(19) United States
(12) Patent Application Publication
(10) Pub. No.: US 2017/0169481 A1
(43) Pub. Date: Jun. 15, 2017

(54) INTERNET-BASED DISPLAY MATERIAL SYSTEM AND INTERNET-BASED DISPLAY MATERIAL PRODUCING METHOD

(71) Applicant: BEIJING KNET EQXIU TECHNOLOGY CO., LTD., Beijing (CN)

(72) Inventors: DIANSHENG LU, BEIJING (CN); JIN HUANG, BEIJING (CN); WEI MAO, BEIJING (CN); WEIMING ZHU, BEIJING (CN); XU LIU, BEIJING (CN); YI TANG, BEIJING (CN); QING LI, BEIJING (CN); HENGHU CAO, BEIJING (CN); JINGUO ZHU, BEIJING (CN)

(21) Appl. No.: 15/151,331

(22) Filed: May 10, 2016

(30) Foreign Application Priority Data
Dec. 15, 2015 (CN) 201510933903.X

(51) Int. Cl. G06Q 30/02; G06F 3/0484; G06F 17/21; G06F 17/24; G06F 17/22

(52) U.S. Cl. CPC G06Q 30/0276; G06F 17/248; G06F 17/2247; G06F 17/211; G06F 17/245; G06F 3/0484

(57) ABSTRACT

The present invention provides an Internet-based display material system and a method thereof, the system is applied at personal computer PC side, including: a page template module, configured to provide page design template of display material; an element component module, configured to provide design source material of the display material; an editing module, configured to edit the page design template of the display material and the design source material of the display material; a page processing module, configured to process page edited by the editing module; and a publishing module, configured to publish the display material processed by the page processing module to an Internet social networking platform. Through the system provided by the present invention, the user can conveniently design desired display material, and modify, update and publish the display material at any time, therefore, the system is time efficient and suitable for rapid development of the enterprise.

### CROSS-REFERENCE TO RELATED APPLICATIONS

This application claims priority to Chinese Patent Application No. 201510933903.X, filed on Dec. 15, 2015, the content of which is incorporated herein by reference in its entirety.

### TECHNICAL FIELD

The present invention relates to the field of Internet technology and, in particular, to an Internet-based display material system and an Internet-based display material producing method.

### BACKGROUND

With the rapid development and popularization of the mobile network, Internet marketing has become an important means for an enterprise to display and promote its own products or services. An enterprise user usually introduces products or services of the enterprise via a display material and promotes the display material over the Internet. The display material particularly can include contents, such as text, picture, animation and video.

In the prior art, if the enterprise user intends to design and promote a display material over the Internet, multiple links, such as static page design, page code development, third-party testing, third-party deployment are needed.

However, various problems, for example, substantial enterprise resources are consumed, procedures are lengthy, adjustments are complicated, occurred in the prior art.

### SUMMARY

Embodiments of the present invention provide an Internet-based display material system and an Internet-based display material producing method, so as to solve the problem in the prior art that the manner for designing a display material of the enterprise consumes substantial enterprise resources.

Embodiments of the present invention provide an Internet-based display material system applied at a personal computer PC side, including:

a page template module, configured to provide a page design template of a display material;

an element component module, configured to provide a design source material of the display material;

an editing module, configured to edit the page design template of the display material and the design material of the display material;

a page processing module, configured to process a page edited by the editing module; and

a publishing module, configured to publish the display material processed by the page processing module to an Internet social networking platform.

In another embodiment, the system further includes:

an auditing module, configured to audit the display material according to number of views and/or contents of the published display material.

In another embodiment, the auditing module is further configured to audit according to a screening condition input by a user.

In another embodiment, the system further includes:

a setting module, configured to set a publishing attribute of the display material.

In another embodiment, the setting module includes a basic setting sub-module and a sharing setting sub-module,

the basic setting sub-module is configured to set a playing display attribute of the display material;

the sharing setting sub-module is configured to set a sharing publishing requirement of the display material.

In another embodiment, the page template module includes one or more of a format template, a style template, an interactive interface template and a self-defined template.

In another embodiment, the element component module includes a combination of any one or more of text, picture, music, video, interaction, form and special-effect element components.

In another embodiment, the interaction element component is configured to conduct interaction settings on contents generated by other element components in the element component, and the interaction settings enable a customer to interact with contents of the display material.

In another embodiment, the form element component is configured to design a customer information collecting table.

In another embodiment, the system further includes a creating module, configured to create a blank design page for a display material, or create the display material by a display material sample template.

In another embodiment, the system further includes a user account managing module, configured to manage rights of using the page template module, the element component module, the editing module, the page processing module and the publishing module.

Embodiments of the present invention also provide an Internet-based display material producing method, including:

providing a page design template of a display material;

providing a design element component of the display material;

editing the page design template of the display material and the design element component of the display material;

processing the edited page of the display material; and

publishing the processed display material to an Internet social networking platform.

In another embodiment, the method further includes:

auditing the display material according to number of views and/or contents of the published display material.

In another embodiment, the method further includes:

auditing the display material according to a screening condition input by a user.

In another embodiment, the method further includes:

setting a publishing attribute of the display material.

In another embodiment, the setting the publishing attribute of the display material, includes:

setting a playing display attribute of the display material; and

setting a sharing publishing requirement of the display material.

In another embodiment, the providing the page design template of the display material comprises: providing one or more of a format template, a style template, an interactive interface template and a self-defined template.

In another embodiment, the providing the design element component of the display material comprises: providing a combination of any one or more of text, picture, music, video, interaction, form and special-effect element components.

In another embodiment, the method particularly includes:

conducting, by the interaction element component, interaction settings on contents generated by other element components in the element component.

In another embodiment, the method particularly includes:

designing, by the form element component, a customer information collecting table.

In another embodiment, the method further includes: creating a blank design page for a display material, or creating the display material by a display material sample template.

In another embodiment, the method further includes: managing user rights of editing the page design template of the display material and the design element component of the display material, managing the page of the display material, and publishing the display material.

Embodiments of the present invention also provide an Internet-based display material system, including: a processor and a memory for storing instructions to be executed, when the system is in operation, the processor communicates with the memory, and the processor executes the instructions, so that the system executes any of the methods described above.

In the Internet-based display material system and the Internet-based display material producing method provided in the embodiments of the present invention, the design template of the page template module and the element component module provide a large number of page design templates and design elements of the display material, the editing module edits design templates of the page template module and design elements of the element component module, the page processing module processes the pages of the display material, so that display materials that meet the user's demands can be designed, and popularized by publishing to an Internet social networking platform via the publishing module. In the Internet-based display material system provided in the embodiments of the present invention, the user can conveniently design the desired display material, and can modify, update and publish the display material at any time, therefore, the system is so time efficient that it is suitable for rapid development of the enterprise.

### BRIEF DESCRIPTION OF DRAWINGS

In order to illustrate embodiments of the present invention or the technical solution in the prior art more clearly, accompanying drawings needed for describing the embodiments or the prior art will be introduced in brief hereinafter. Apparently, the accompanying drawings show certain embodiments of the invention, and persons skilled in the art can derive other drawings from them without creative efforts.

FIG. 1 is a schematic structural diagram of an Internet-based display material system according to an embodiment of the present invention;

FIG. 2 is a schematic structural diagram of an Internet-based display material system according to another embodiment of the present invention;

FIG. 3 is a schematic diagram of a graphic user interface GUI of an Internet-based display material system according to an embodiment of the present invention;

FIG. 4 is a schematic structural diagram of an Internet-based display material system according to still another embodiment of the present invention;

FIG. 5 is a schematic diagram of a graphic user interface GUI of an Internet-based display material system according to an embodiment of the present invention;

FIG. 6 is a schematic diagram of a publishing manner setting interface in a graphic user interface GUI of an Internet-based display material system according to an embodiment of the present invention; and

FIG. 7 is a schematic diagram of a setting interface in a graphic user interface GUI of an Internet-based display material system according to an embodiment of the present invention.

### DESCRIPTION OF EMBODIMENTS

In order to make the objects, technical solutions, and advantages of the embodiments of the present invention clearer, the technical solutions in the embodiments of the present invention are hereinafter described clearly and completely with reference to the accompanying drawings in the embodiments of the present invention. Obviously, the embodiments described here are part of the embodiments of the present invention and not all of the embodiments. All other embodiments, which can be derived by persons skilled in the art from the embodiments given herein without creative efforts, shall fall within the protection scope of the present invention.

Embodiments of the present invention provide an Internet-based display material system, for assisting a user to design products to be promoted or display materials for service, and achieving rapid propaganda and popularization of the products or services by publishing the display material over a network.

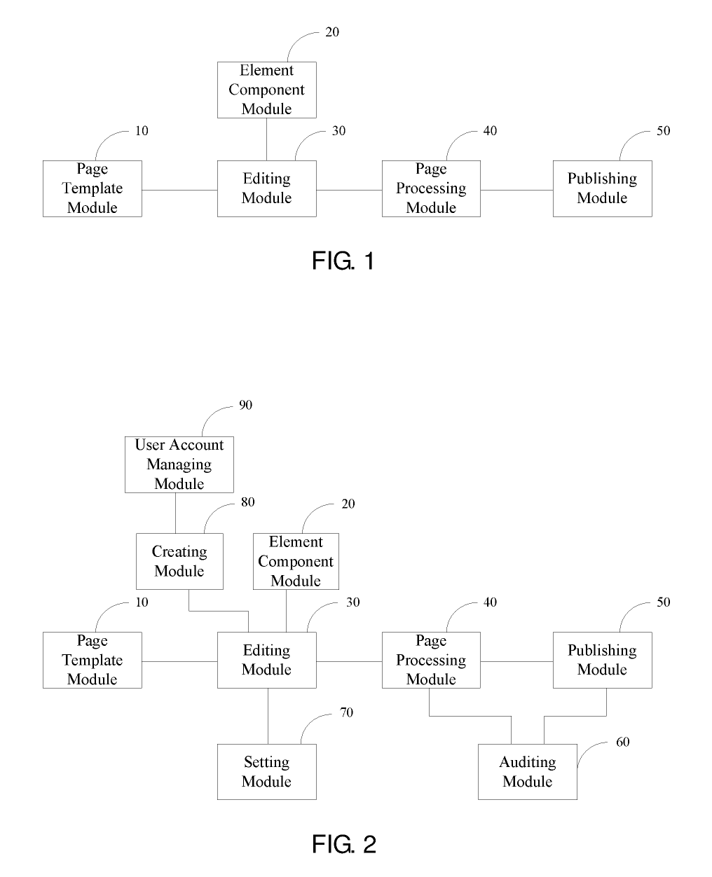

FIG. 1 is a schematic structural diagram of an Internet-based display material system according to an embodiment of the present invention. Please refer to FIG. 1, the

Internet-based display material system provided in the embodiments of the present invention is applied at a personal computer (Personal Computer, PC) side, and at least includes: a page template module 10, an element component module 20, an editing module 30, a page processing module 40 and a publishing module 50.

The page template module 10 is configured to provide a page design template of a display material;

the element component module 20 is configured to provide a design source material of the display material;

the editing module 30 is configured to edit the page design template of the display material and the design source material of the display material;

the page processing module 40 is configured to process a page edited by the editing module 30; and

the publishing module 50 is configured to publish the display material processed by the page processing module 40 to an Internet social networking platform.

In particular, the editing module 30 can produce an editing interface simulate a cellphone display mode, to facilitate the published display material to be viewed on the cellphone. The editing interface includes a design area and a setting area, and the setting area is provided with a plurality of function buttons for setting grids and auxiliary lines of the design area, undoing and redoing design steps and previewing designed pages. Optionally, the setting area is located on the left of the design area. Some common element components of the element component module 20 can be shown on the right of the design area, to facilitate designing of the common element components.

The page template module 10 is configured to provide a plurality of page design templates, so that the user can design a desired display material directly with the page design templates. Particularly, the page design template includes an independent user template, to generate consistent page templates for authorized users and achieve consistency of propagation and marketing management.

In particular, the page template module 10 can be configured to provide one or more of a format template, a style template, an interactive interface template and a self-defined template. The format template is configured to provide various different layout display formats for the user, the style template is configured to provide various different design styles for the user, the interactive interface template is configured to provide the user with various design interfaces to interact with the customer, such as a form, so that the user can feed information back by filling in contents on the form. The self-defined template is configured to take the completed design page saved by the user as a template, so that the user can use it directly next time. Optionally, the page template module 10 also includes a search module, so that the user can search for the desired template.

The element component module 20 is configured to provide a design source material for page contents of the display material. In particular, the element component provided by the element component module 20 includes text, font, picture, background, shape, video, music, picture collection, interaction, form, special-effect or the like. In particular, the font element toolbar is configured to assist the user to design various fonts, generate pictures and make animation and trigger setting for the generated fonts. The picture element component is configured to assist the user to add pictures in a gallery or self-defined pictures in the page, and set the size, animation, sound effect and triggering mode of the picture. The background element component is configured to assist the user to add a picture in a gallery or a self-defined picture as a background of the whole page, and set attributes of the background. The shape element component is configured to provide various common graphic patterns for the user, and assist the user to make some basic settings, such as color, size and animation to these graphic patterns. The video element component is configured to add an external video link in a page of the display material, so as to achieve a function of playing video contents in the page of the display material; the music element component is configured to assist the user to add a music in a gallery or a self-defined music as a background music of the whole display material. The picture collection element component is configured to assist the user to add a picture collection in the page, the picture collection consists of multiple pictures displayed by turns according to a setting mode, and the user can set a page-turning mode and time of these pictures depending on design requirements. The interaction element component is configured to conduct interaction settings on contents generated by other element components in the element component, by means of the interaction settings, a browsing user can interact with contents of the display material, for example, vote, like, trigger an animation and trigger a sound effect. The form element component is configured to design a customer information collecting table, and a customer browsing the display material can submit the customer information via the customer information collecting table. The special-effect element component is configured to add special effects on the basis of original page contents depending on the user requirement, for example, a snowflake effect enables an effect of snowing in the page, and a fingerprint effect simulates an opening effect by inputting a fingerprint, once the customer clicks the screen.

The page processing module 30 is configured to process a page of the display material. For example, the page processing module 30 can add, delete, insert, copy pages, or edit page names, or adjust a sequence of pages.

In the Internet-based display material system provided in the embodiments of the present invention, the design template of the page template module and the element component module provide a large number of page design templates and design elements of the display material, the editing module edits design templates of the page template module and design elements of the element component module, the page processing module processes the pages of the display material, so that display materials that meet the user's demands can be designed, and the publishing module publishes the display material to an Internet social networking platform for propagandizing and popularizing. In the Internet-based display material system provided in the embodiments of the present invention, the user can conveniently design the desired display material, and can modify, update and publish the display material at any time, therefore, the system is so time efficient that it is suitable for rapid development of the enterprise.

FIG. 2 is a schematic structural diagram of an Internet-based display material system according to another embodiment of the present invention. Please refer to FIG. 2, furthermore, in order to prevent contents violating laws and regulations from appearing in the display material, the system also includes:

an auditing module 60, configured to audit the display material according to number of views and/or contents of the published display material. In particular, the auditing module 60 is further configured to audit according to a screening condition input by a user. The auditing process can be a two-level auditing process, one is executed by the system, the other is executed manually by an audit staff, and the two processes are to screen and filter illegal contents of the display material, respectively.

Furthermore, in order to make the publishing mode of the display material more flexible, the system also includes:

a setting module 70, configured to set a publishing attribute of the display material. In particular, the setting module 70 includes a basic setting sub-module and a sharing setting sub-module.

The basic setting sub-module is configured to set a playing display attribute of the display material. The display attribute can include: name, content description, displayed cover and display link of the display material, and the display link is directed to contents to be added in the page of the display material.

The sharing setting sub-module is configured to set a sharing publishing requirement of the display material, and the sharing publishing requirement can include: a sharing selecting mode and an access password.

The setting module 70 also can include a friendship setting sub-module, configured to set whether to keep the trademark of the system supplier, or the like.

Furthermore, to facilitate the user to create the display material depending on design requirements, the system also includes a creating module 80. The creating module 80 is configured to create a blank design page for a display material, or create the display material by a display material sample template.

Before designing and editing the display material with the editing module 30, the user can select to create a blank page or create a page according to a sample mode with the creating module 80. When selecting to create a blank page, the user can design and produce the display material according to the user's need on a completely blank page; when selecting to create according to a sample mode, the user can create a page with various sample templates given by the system. In particular, the sample template is a display material with a complete design, and is characterized in that the user can totally use the samples, modify and edit sample contents according to the user's need, to facilitate the user to create a complete display material rapidly by means of samples.

Furthermore, in order to facilitate the user to design the display material with the Internet-based display material system and maintain and publish the designed display material in time, the system also includes a user account managing module 90, configured to manage rights of using the page template module, the element component module, the editing module, the page processing module and the publishing module. The user can apply for an account with the user account managing module 90, and login the Internet-based display material system with the account to design the display material, and edit, modify and publish the display material created by the account.

When the display material is designed and published with the Internet-based display material system, a design page for the display material is firstly created with the creating module 90, contents of the display material are produced in the editing module 30 by means of the page template module 10, the element component module 20, and the page processing module 40, then attributes are set in the setting module of the display material, contents of the display material are audited in the auditing module 60, the audited display material is published to an Internet social networking platform with the publishing module 50.

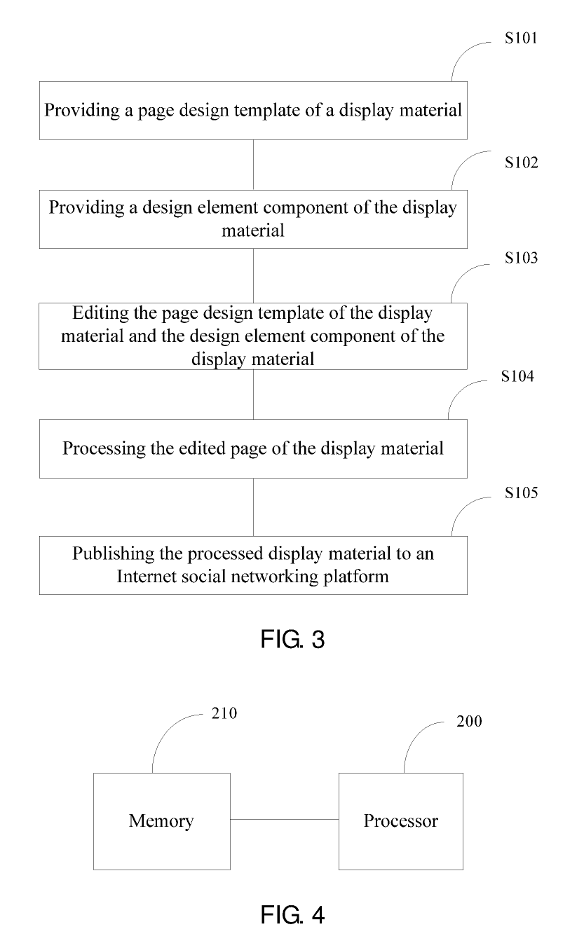

FIG. 3 is a schematic flowchart of an Internet-based display material producing method according to an embodiment of the present invention. Please refer to FIG. 3, embodiments of the present invention further provide an Internet-based display material producing method, including:

S101, Providing a page design template of a display material;

S102, Providing a design element component of the display material;

S103, Editing the page design template of the display material and the design element component of the display material;

S104, Processing the edited page of the display material; and

S105, Publishing the processed display material to an Internet social networking platform.

In the Internet-based display material producing method provided in the embodiments of the present invention, a large number of page design templates and design elements of the display material are provided, design templates of the page template module and design elements of the element component module are edited, and the pages of the display material are managed, so that display materials that meet the user's demands can be designed, and popularized by publishing the display material to an Internet social networking platform. In the Internet-based display material producing method provided in the embodiments of the present invention, the user can conveniently design the desired display material, and can modify, update and publish the display material at any time, therefore, the system is so time efficient that it is suitable for rapid development of the enterprise.

Optionally, the method further includes:

auditing the display material according to number of views and/or contents of the published display material.

Optionally, the method further includes:

auditing the display material according to a screening condition input by a user.

Optionally, the method further includes:

setting a publishing attribute of the display material.

Optionally, the setting the publishing attribute of the display material includes:

setting a playing display attribute of the display material; and

setting a sharing publishing requirement of the display material.

Optionally, the providing the page design template of the display material includes: providing one or more of a format template, a style template, an interactive interface template and a self-defined template.

Optionally, the providing the design element component of the display material includes: providing a combination of any one or more of text, picture, music, video, interaction, form and special-effect element components.

Optionally, the method particularly includes:

conducting, by the interaction element component, interaction settings on contents generated by other element component in the element component.

Optionally, the method particularly includes:

designing, by the form element component, a customer information collecting table.

Optionally, the method further includes: creating a blank design page for a display material, or creating the display material by a display material sample template.

Optionally, the method further includes: managing user rights of editing the page design template of the display material and the design element component of the display material, managing the page of the display material, and publishing the display material.

FIG. 4 is a schematic structural diagram of an Internet-based display material system according to still another embodiment of the present invention. Please refer to FIG. 4, the Internet-based display material system provided in embodiments of the present invention, includes: a processor 200 and a memory 210 for storing instructions to be executed, when the system is in operation, the processor 200 communicates with the memory 210, and the processor executes the instructions, so that the system executes any of the methods described above, the technical effect and the implementation principle thereof are similar to those of the method embodiment, and no further details will be given here.

The present invention also provides a graphic user interface (Graphic User Interface, GUI) of an Internet-based display material system, for assisting a user to design products or display materials to be serviced, and achieving propaganda and popularization of the products or services of the user by publishing the display material to an Internet social networking platform. The GUI is applied at a personal computer side.

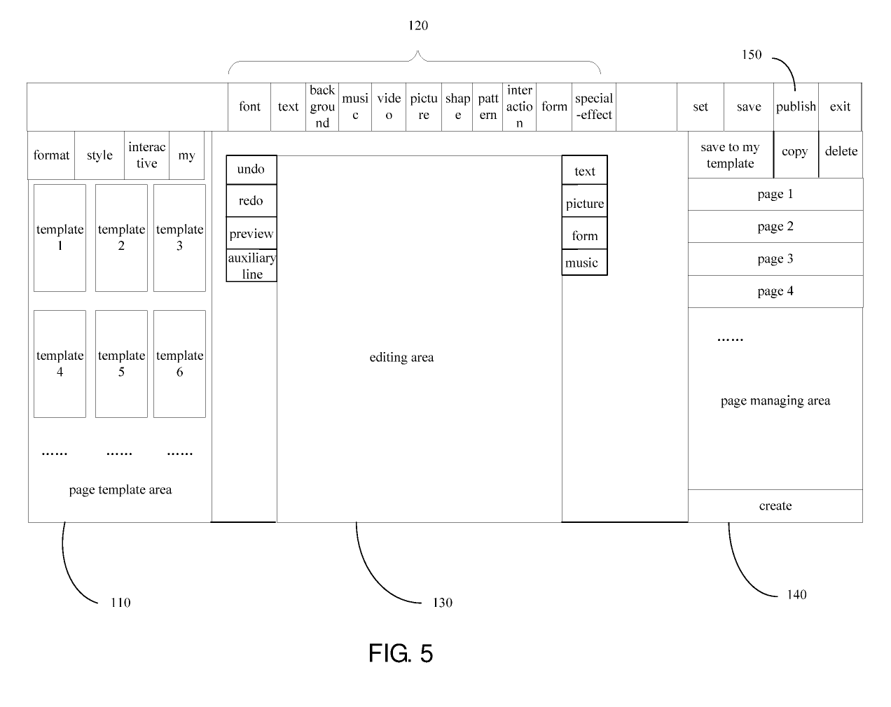

FIG. 5 is a schematic diagram of a graphic user interface GUI of an Internet-based display material system according to an embodiment of the present invention. Please refer to FIG. 5, the GUI provided in the embodiments of the present invention includes:

a page template area 110, configured to display a page design template of a display material;

an element component toolbar 120, configured to display a design element component of the display material, wherein, the user can select the element component in the element component toolbar 120 to design the display material;

an editing area 130, configured for the users to edit the page design template of the display material selected by the page template area 110 and edit the design element component provided by the element component toolbar 120;

a page processing area 140, configured for the users to process pages of the edited display material;

a publish button 150, configured for the user to publish the display material processed by the page processing module to an Internet social networking platform.

In particular, the editing area 130 is located in the center of the GUI of the Internet-based display material system, and can simulate a cellphone display mode, to facilitate the published display material to be viewed on the cellphone. Optionally, there can be an editing and setting area on the left of the editing area 30, and the editing and setting area is provided with a plurality of function buttons for setting grids and auxiliary lines of the editing area 30, undoing and redoing design steps and previewing designed pages. Some common element components of the element component toolbar 120 can be shown on the right of the editing area 30, to facilitate design with the common element components.

The page template area 110 is located on the left of the editing area 130, and can display a plurality of page design templates, so that the user can design the desired display material directly with the page design templates.

In particular, the page template area 110 includes one or more template type select buttons. When there are multiple template type selecting buttons, the buttons can be arranged in parallel, which indicates different types of templates, respectively. For example, the template type can be a format template, a style template, an interactive interface template and a self-defined template. The user selects one of the template type selecting buttons to display the corresponding type of template in the page template area 110. The format template is configured to provide various different layout display formats for the user; the style template is configured to provide various different design styles for the user. The interactive interface template is configured to provide the user with various design interfaces to interact with the customer, such as a form, so that the user can feed information back by filling in contents on the form. The self-defined template is configured to take the completed design page saved by the user as a template, so that the user can use it directly next time. Particularly, the self-defined template also can include an independent user template, to generate consistent page templates for authorized users and achieve consistency of propagation and marketing management. Optionally, the page template area 110 also can include a search button, so that the user can search for the desired template.

The element component toolbar 120 is arranged on top of the editing area 130, and the user can complete a page content design of the display material with an element component provided by the element component toolbar 120. In particular, the element component provided by the element component toolbar 120 includes text, font, picture, background, shape, video, music, picture collection, interaction, form, special-effect or the like. In particular, the font element toolbar is configured to assist the user to design various fonts, generate pictures and make animation and trigger setting for the generated fonts. The picture element component is configured to assist the user to add pictures in a gallery or self-defined pictures in the page, and set the size, animation, sound effect and triggering mode of the picture. The background element component is configured to assist the user to add pictures in a gallery or self-defined pictures as the background of the whole page, and set attributes of the background. The shape element component is configured to provide various common graphic patterns for the user, and assist the user to make some basic settings, such as color, size and animation to these graphic patterns. The video element component is configured to add an external video link in a page of the display material, so as to achieve a function of playing video contents in the page of the display material; the music element component is configured to assist the user to add a music in a gallery or a self-defined music as a background music of the whole display material. The picture collection element component is configured to assist the user to add a picture collection in the page, the picture collection consists of multiple pictures displayed by turns according to a setting mode, and the user can set a page-turning mode and time of these pictures depending on design requirements. The interaction element component is configured to conduct interaction settings on contents generated by other element components in the element component, by means of the interaction settings, a browsing user can interact with contents of the display material, for example, vote, like, trigger an animation and trigger a sound effect. The form element component is configured to design a customer information collecting table, and a customer browsing the display material can submit the customer information via the customer information collecting table. The special-effect element component is configured to add special effects on the basis of original page contents depending on the user requirement, for example, a snowflake effect enables an effect of snowing in the page, and a fingerprint effect simulates an opening effect by inputting a fingerprint, once the customer clicks the screen.

The page processing area 140 is located on the right of the editing area 130, and configured to process pages of the display material. The page processing area 140 is provided with a create button at the bottom, a save button, a copy button and a delete button on the top, and a page list display area in the center. The page can be created, deleted and copied with the create button, the copy button and the delete button, and the page can be saved as a self-defined template with the save button. Additionally, page names can be edited or a sequence of pages can be adjusted in the page list display area.

The publish button 150 is arranged on the right of the element component toolbar 120, located on the above of the page processing area 140, and configured to publish the display material processed by the page processing module 40 to an Internet social networking platform.

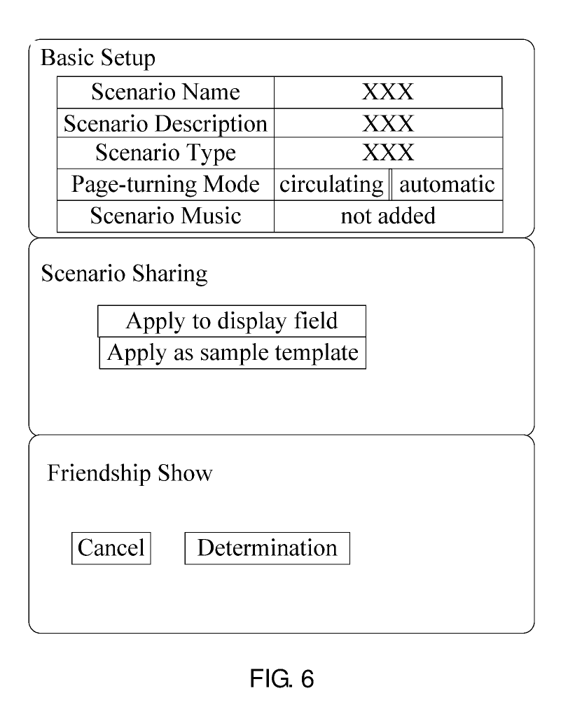

FIG. 6 is a schematic diagram of a publishing manner setting interface in a graphic user interface GUI of an Internet-based display material system according to an embodiment of the present invention. Please refer to FIG. 6, particularly, click the publish button 150 to enter the publishing manner setting interface, which provides a cellphone scanning two-dimensional code sharing button, a scenario network address sharing button and a computer tool sharing button. A corresponding area of the cellphone scanning two-dimensional code sharing button is provided with a two-dimensional code and links of cellphone application softwares, such as WeChat, QQ, Qzone, MicroBlog, Baidu Post Bar and Message. The user can publish the display material on corresponding cellphone application by scanning the two-dimensional code with a cellphone, or publish the two-dimensional code of the display material through some other channels by downloading the two-dimensional code picture. The scenario network address sharing button can set an extension for the network address of the display material, and publish the display material to different channels by distributing the extension of the network address, so that the user can monitor and manage publishing effects of the various channels, and evaluate the effect of each risk channel conveniently.

It will be appreciated that the relative positional relationship between each area and the function buttons is only directed at the GUI of the Internet-based display material system for illustrative purposes, and not limited thereto. The relative positional relationship between respective areas also can be adjusted as required. The function button of respective area also can be displayed in the form of a chart.

In the GUI of the Internet-based display material system provided in the embodiments of the present invention, the user can select the desired page design template in the page template area, design the element component of the display material with the element component toolbar 120, edit the page design template and the element component in the editing area, process pages of the display material in the page processing area to design the display material that meets the user's demands, and publish the display material to an Internet social networking platform with the publishing button, so as to popularize the display material. In the GUI of the Internet-based display material system provided in the embodiments of the present invention, the user can conveniently design the desired display material, and can modify, update and publish the display material at any time, therefore, the system is so time efficient that it is suitable for rapid development of the enterprise.

Furthermore, in order to make a publishing mode of the display material more flexible, the GUI also includes:

a setting button 70, configured to set a publishing attribute of the display material. In particular, the setup button is arranged in parallel with the publish button, and located on the above of the page processing area 140.

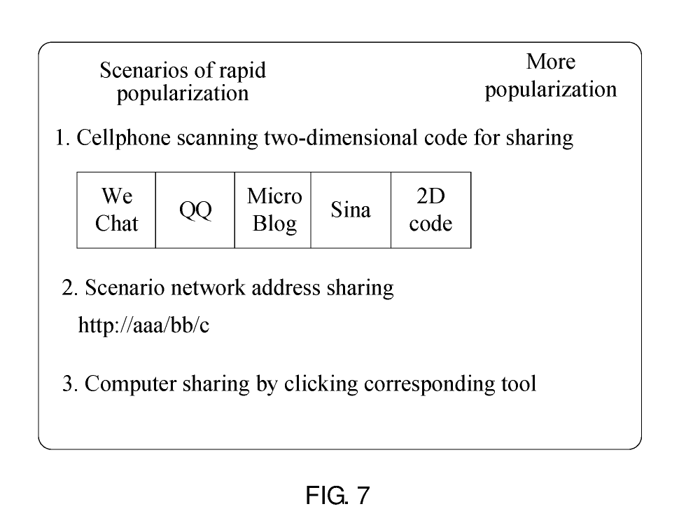

FIG. 7 is a schematic diagram of a setting interface in a graphic user interface GUI of an Internet-based display material system according to an embodiment of the present invention. Please also refer to FIG. 7, click the setup button to enter the setting interface, which includes a basic setting area, a sharing setting area and a friendship setting area.

The basic setting area is configured to set a playing display attribute of the display material. The display attribute can include: name, content description, displayed cover and display link of the display material, and the display link is directed to contents to be added in the page of the display material.

The sharing setting area is configured to set a sharing publishing requirement of the display material, and the sharing publishing requirement can include: a sharing selecting mode and an access password.

The friendship setting area is configured to set whether to keep the trademark of the system supplier, or the like.

To facilitate to manage the designed display material, the GUI also includes a save button, configured to save the designed display material. Additionally, to facilitate switching a system login account, the GUI also includes a logout button, once the logout button is clicked, the user can exit the current login account. In particular, the save button, the logout button, the setting button and the publish button are arranged in parallel, and located on the above of the page processing area 140.

When the display material is designed and published with the GUI of the Internet-based display material system, the user can select the page design template in the page template area, select the desired element component in the element component toolbar, edit the page template and the element component in the editing area, process pages of the display material in the page processing area, and publish the produced display material to an Internet social networking platform with the publishing button.

The present invention also provides a computer readable storage medium including program instructions for enabling a computer to:

provide a page design template of a display material;

provide a design source material of the display material;

edit the page design template of the display material and the design source material of the display material;

process a page edited by the editing module; and

publish the display material processed by the page processing module to an Internet social networking platform.

In the computer readable storage medium provided in the embodiments of the present invention, the program instructions in the storage medium enable the computer to provide a large number of page design templates and design elements of the display material, edit the page design template and design elements, and process the pages of the display material, so that the user can design display material that meets the user's demands, publish the display material to an Internet social networking platform by operating the computer, popularize the display material, and can modify, update and publish the display material at any time, therefore, the system is so time efficient that it is suitable for rapid development of the enterprise.

Furthermore, in order to prevent contents violating laws and regulations from appearing in the display material, the program instruction is further configured to enable the computer to:

auditing the display material according to number of views and/or contents of the published display material.

Furthermore, in order to make a publishing mode of the display material more flexible, the program instruction is further configured to enable the computer to:

set a publishing attribute of the display material. Particularly, the computer can enable to set a playing display attribute of the display material, such as name, content description, displayed cover and display link of the display material, and the display link is directed to contents to be added in the page of the display material; to set a sharing publishing requirement of the display material, such as a sharing selecting mode and an access password; and to set whether to keep the trademark of the system supplier, or the like.

Furthermore, to facilitate the user to create the display material depending on design requirements, the program instruction is further configured to enable the computer to: create a blank design page for a display material, or create the display material by a display material sample template.

Furthermore, to facilitate the user to design the display material using the computer, maintain and publish the designed display material in time, the program instruction is further configured to enable the computer to manage a right of using the user account. The user can operate the computer to achieve the above functions through the user account, and edit, modify and publish the display material created by the account.

The present invention also provides a computer readable storage medium including program instructions for enabling a computer to display any one of the user interfaces described above.

Finally, it should be noted that the above embodiments are merely provided for describing the technical solutions of the present invention, but not intended to limit the present invention. It should be understood by persons skilled in the art that although the present invention has been described in detail with reference to the foregoing embodiments, modifications can be made to the technical solutions described in the foregoing embodiments, or equivalent replacements can be made to partial or all technical features in the technical solutions; however, such modifications or replacements do not cause the essence of corresponding technical solutions to depart from the scope of the embodiments of the present invention.

What is claimed is:

1. An Internet-based display material system applied at a personal computer PC side, comprising:
a page template module, configured to provide a page design template of a display material;
an element component module, configured to provide a design element component of the display material;
an editing module, configured to edit the page design template of the display material and the design element component of the display material;
a page processing module, configured to process a page edited by the editing module; and
a publishing module, configured to publish the display material processed by the page processing module to an Internet social networking platform.

2. The system according to claim 1, further comprising:
an auditing module, configured to audit the display material according to number of views and/or contents of the published display material.

3. The system according to claim 2, wherein, the auditing module is further configured to audit according to a screening condition input by a user.

4. The system according to claim 1, further comprising:
a setting module, configured to set a publishing attribute of the display material.

5. The system according to claim 4, wherein, the setting module comprises a basic setting sub-module and a sharing setting sub-module,
the basic setting sub-module is configured to set a playing display attribute of the display material;
the sharing setting sub-module is configured to set a sharing publishing requirement of the display material.

6. The system according to claim 1, wherein, the page template module provides one or more of a format template, a style template, an interactive interface template and a self-defined template.

7. The system according to claim 1, wherein, the element component module provides a combination of any one or more of text, picture, music, video, interaction, form and special-effect element components.

8. The system according to claim 7, wherein:
the interaction element component is configured to conduct interaction settings on contents generated by other element components in the element component, and the interaction settings enable a customer to interact with contents of the display material.

9. The system according to claim 7, wherein, the form element component is configured to design a customer information collecting table.

10. The system according to claim 1, further comprising a creating module, configured to create a blank design page for a display material, or create the display material by a display material sample template.

11. The system according to claim 1, further comprising a user account managing module, configured to manage rights of using the page template module, the element component module, the editing module, the page processing module and the publishing module.

12. An Internet-based display material producing method, comprising:
providing a page design template of a display material;
providing a design element component of the display material;
editing the page design template of the display material and the design element component of the display material;
processing the edited page of the display material; and
publishing the processed display material to an Internet social networking platform.

13. The method according to claim 12, further comprising:
auditing the display material according to number of views and/or contents of the published display material.

14. The method according to claim 12, further comprising:
auditing the display material according to a screening condition input by a user.

15. The method according to claim 12, further comprising:
setting a publishing attribute of the display material.

16. The method according to the claim 15, wherein, the setting the publishing attribute of the display material, comprises:
setting a playing display attribute of the display material; and
setting a sharing publishing requirement of the display material.

17. The method according to claim 12, wherein, the providing the page design template of the display material comprises: providing one or more of a format template, a style template, an interactive interface template and a self-defined template.

18. The method according to claim 12, wherein, the providing the design element component of the display material comprises: providing a combination of any one or more of text, picture, music, video, interaction, form and special-effect element components.

19. The method according to claim 18, comprising:
conducting, by the interaction element component, interaction settings on contents generated by other element components in the element component.

20. The method according to claim 18, wherein, designing, by the form element component, a customer information collecting table.

21. The method according to claim 12, further comprising: creating a blank design page for a display material, or creating the display material by a display material sample template.

22. The method according to claim 12, further comprising: managing user rights of editing the page design template of the display material and the design element component of the display material, managing the page of the display material, and publishing the display material.

23. An Internet-based display material system, comprising: a processor and a memory for storing instructions to be executed, when the system is in operation, the processor communicates with the memory, and the processor executes the instructions, so that the system executes the method according to claim 12.
